(19) United States
(12) Patent Application Publication
(10) Pub. No.: US 2015/0109582 A1
(43) Pub. Date: Apr. 23, 2015

(54) PROJECTOR WITH VARIABLE POWER CONSUMPTION BASED ON DATA RECEIVED FROM REMOVABLE MODULE

(71) Applicant: 3M INNOVATIVE PROPERTIES COMPANY, St. Paul, MN (US)

(72) Inventors: Ernesto M. Rodriguez, JR., Austin, TX (US); Shuguang Wu, Austin, TX (US); James K. Kennedy, Round Rock, TX (US)

(21) Appl. No.: 14/398,506

(22) PCT Filed: Feb. 13, 2013
(86) PCT No.: PCT/US2013/025885

§ 371 Date: Nov. 3, 2014

Related U.S. Application Data
(60) Provisional application No. 61/642,734, filed on May 4, 2012.

(51) Int. Cl. H04N 9/31

(52) U.S. Cl. CPC H04N 9/3155; H04N 9/3173
USPC 353/15; 353/85; 353/121

(57) ABSTRACT

An electronic unit that include a projector (100) and removable module (102) that communicates data to the projector (100), wherein the projector (100) alters its power consumption in response to data received from the removable module (102).

### FIELD

The present description relates to electronic units that include projectors and removable modules capable of communicating data to such projectors. More specifically, the present description relates to projectors that are capable of automatically altering their power consumption in response to data received from a modular removable module.

### BACKGROUND

Optical projectors are used to project images onto a surface for viewing by groups of people. Increasingly, there is a desire to miniaturize optical projectors in order to allow for readily mobile projection applications. In response to this desire, a number of mobile projectors have been developed by 3M Company and others. However, more recently, the desire for a greater array of content and capability on mobile projectors has arisen. In the television market, one solution that has been used to increase the content streaming and other functionality of televisions has been so called “Streaming Sticks™” from Roku Inc. (Saratoga, Calif.).

Projectors generally include a battery power supply that powers the device when not connected to an AC power outlet. Additionally, a number of projectors contain settings that may be altered which may aid to maintain the power supplies for longer periods of time. Often times, projectors may be used to view information that is transmitted from a second device. It would be beneficial if the second device was capable of communicating characteristics of the transmitted information and the electronic device was capable of altering its power consumption in response to such information. The present description aims to provide for such a solution.

### SUMMARY

In one aspect, the present description relates to an electronic unit. The electronic unit includes a projector and a removable module. The removable module communicates a first set of data to the projector regarding various functions that are provided to the projector. The projector automatically alters its power consumption in response to the first set of data received from the removable module in order to optimize use time with the various functions. In some embodiments, the removable module may communicate a plurality of sets of data following the first set of data, such that the projector may continually alter its power consumption and other functionality in response to the sets of data received from the removable module.

In at least one embodiment, the projector will be a pico projector. The removable module may be a streaming information sharing stick, module or drive, or may be a laptop, tablet, PC, DVD player, cable box, or the like. The removable module may be connected to the projector through a port by MHL, HDMI, or other appropriate connection, or may be connected through a wireless connection. Where a wireless connection is utilized, the communication link may be through a WiFi, WiGiG, Miracast or other wireless protocol, and governance of the first set of data being communicated/transmitted wirelessly may occur through a software application.

The projector may alter its power consumption by dimming a light source used to project an image. In one embodiment, the first set of data communicated to the projector from the removable module may be the run time of a movie. In such an embodiment, the projector may alter its power consumption by dimming a light source used to project or display the image of the movie to allow completion of the movie. In such an embodiment, the projector may be capable of sending a return message to the removable module that the power remaining in the projector's power source is insufficient to complete a movie even with light source dimming, thereby requiring a user to utilize an external power source. The projector may be powered by a battery power source or power adapter configured to provide power to the projector.

In other embodiments, the first set of data communicated to the projector from the removable module may be a pause or stop function, the necessity of audio only, or a commercial or other break. Each of these sets of data may result in the projector altering power consumption by automatically turning off the projector light source or potentially dimming the light source.

In another aspect, the present description relates to a method of continually controlling the power supply of an electronic device. The electronic device includes a projector and removable module. The method includes the steps of a) communicating a first set of a data from the removable module to the projector regarding various functions being provided to the projector, and b) automatically altering the power consumption of the projector in response to the first set of data received from the removable module in order to optimize use time with the various functions. The projector and removable module as well as the sets of data communicated may be similar to those described with respect to the electronic unit above. Additionally, the method may further include communicating further sets of data from the removable module to the projector and continually altering the projector's power consumption and other functionality in response to the sets of data received from the removable module.

### BRIEF DESCRIPTION OF THE DRAWINGS

FIG. 1 is a schematic view of a projector communicating with a connected removable module.

FIG. 2 is a diagram illustrating the operation of an embodiment of the projector and removable module of FIG. 1.

FIGS. 3A, 3B, and 3C are sequential perspective views of a projector with a removable module being inserted.

### DETAILED DESCRIPTION

In the field of projection, it has become increasingly common to include computationally-demanding applications within the projection devices themselves. This trend to add “smart” capabilities is present in other fields of electronics, such as with televisions and mobile phones. While this trend has led to projectors with increased capabilities, the inclusion of these demanding applications has increased the cost of producing such smart projectors. In addition, these applications use and require large amounts of memory, need improved cooling systems due to increased heat generation, and increase the demand on batteries, thereby limiting portability. At the same time, projectors are being designed smaller, lighter, and generally more portable. Mobile projectors are generally more easily moved and transported; may be powered by a battery, by a plug-in power source, or by a combination of the two; and may include pico projectors, handheld projectors, palm projectors, and pocket projectors. Mobile projectors and the like have limited physical space for memory and other components, including less room for a large high-capacity battery. Therefore, there is a need to create portable smart projectors that, while providing broad functionality, minimize the increased power consumption, thermal generation, and memory associated with such functionality. The present description provides a solution to this need by providing a projector that has is capable of communicating its own capabilities with a “smart” input module, receiving input back from such a module, and selectively configuring its systems in order to optimize the projection output based upon information received. This allows the projector to have great functionality without the issues associated with a high number of applications placed directly onto the projector. Embodiments of the present disclosure include projectors that include a plurality of systems and a port adapted to receive and communicate with a removable module. In some embodiments, the projector is capable of indicating the capabilities of at least one of the plurality of systems and the projector is capable of receiving return information from the removable module and selectively configuring the systems of the projector according to the return information when such a module is inserted into the port.

Because certain functionalities of the projector are dependent on the connection of a removable module, the projector may lack some multifunctionality in embodiments where only a single removable module may be connected at a time. Still, in applications where simultaneous capabilities are not required or even desired, limiting the projector to only one or several sets of functions may provide extended battery life, better calibrated and adjusted function-specific optical and thermal settings, and selective activation of components and accessories. In many cases, these advantages may be sufficient to justify the loss of simultaneous broad multifunctionality.

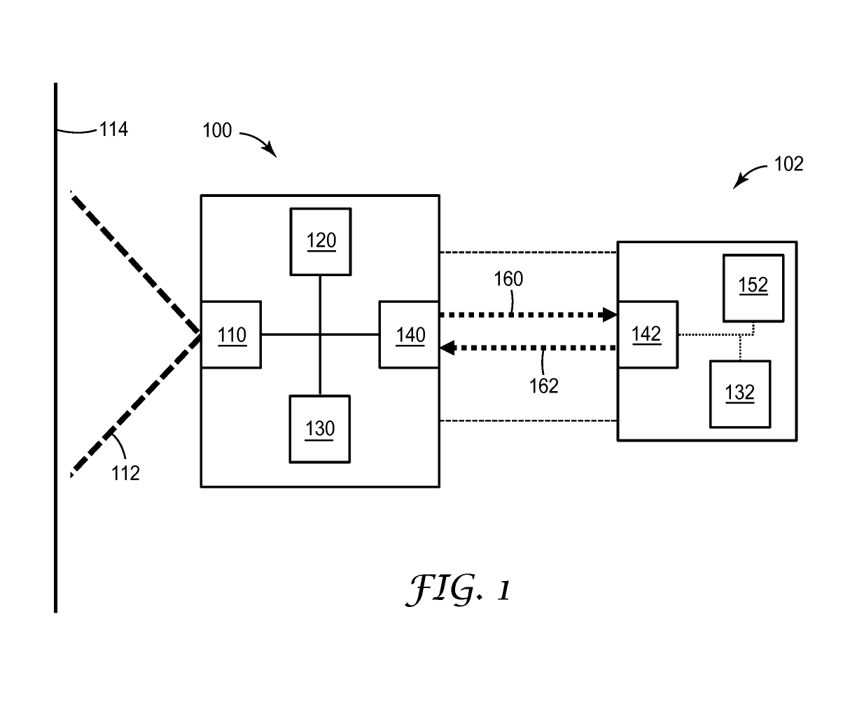

FIG. 1 shows a schematic view of a projector 100 communicating with an attached removable module 102. Projector 100 includes optical system 110 (which includes an optical engine to generate projected light 112 onto projection surface 114), thermal system 120, electronic system 130, and port 140. Removable module 102 includes module electronic system 132, connector 142, and content system 152.

Optical system 110 includes suitable components to facilitate the projection of projected light 112 which may contain text and images. Some attributes and components are static, that is, they will not be adjusted or modified during the normal use of the projector. For example, the shape and size of any mirror or lens in optical system 110 will be unlikely to change during normal use. Other attributes and components are dynamic, that is, they may be configured and changed in the normal use of the projector. In some cases, the gamma, light output, aspect, and contrast ratio may be adjusted to suitable values depending on the lighting environment, the desired mode of projector usage, or other relevant circumstances. For applications where most of the image displayed through projected light 112 is text, high contrast and clarity for readability may be desired and prioritized. Adjustments to optical system 110 may also depend on ambient circumstances rather than the current desired application, or they may depend on ambient circumstances in addition to the current desired application. For certain applications, optical system 110 may be adjusted to generate brighter or dimmer projected light 112 depending on ambient room brightness. In some embodiments, projected light 112 from optical system 110 may depend on the physical orientation of projector 100 (e.g., whether it is placed horizontally, vertically, or upside down); that is, where optical system 110 generates projected light 112 that is correctly orientated on projection surface 114 regardless of the placement of the projector.

Thermal system 120 may include heat management and dissipation components. For example, thermal system 120 may include one or more fans or heat sinks. During normal operation of projector 100, fans of thermal system 120 may be switched to high power, to low power, or completely off, depending on the application. Often, there is a tradeoff between high levels of noise (i.e., due to fans running at high power) and high operating temperature (because fans may cool projector 100 through convection less effectively at low speed). In some embodiments, multiple fans may run at low speed in the place of a single fan operating at high speed. Depending on the desired application, the fans can be adjusted to maximize performance while minimizing operating temperature and noise.

One or more power management components, settings, or profiles may also be included in thermal system 120. Depending on the application, the power profile of thermal system 120 may be adjusted to provide either higher performance or lower power consumption. While generally lower power consumption may be desirable for instances where projector 100 is not connected to external power, i.e., when projector 100 is running on battery power, there may be uses of projector 100 where such a default may be undesirable, or at least not optimal. For example, in applications where high performance is essential, it may be desirable to maintain high power consumption even when projector 100 is running on battery power, regardless of the reduction in battery life. Likewise, in applications where power consumption is not limited by a battery, it may be desirable nonetheless for the power management of thermal system 120 to run projector 100 at lower power to minimize heat generation or the noise created by running one or more fans.

Thermal system 120 may also be adjusted according to ambient or environmental conditions, including but not limited to temperature, humidity, altitude, or background noise levels. Whether or how thermal system 120 is changed according to these parameters may vary depending on the desired application for projector 100.

Electronic system 130 may include drive electronics, software modules, input ports, wireless radios and transmitters, or other related components. For example, electronic system 130 may include a USB (universal serial bus) port which is selectively powered depending on the desired application for projector 100. In other embodiments, electronic system 130 may include a wireless radio, including a Bluetooth® compatible radio (registered trademark of Bluetooth Special Interest Group, Kirkland, Wash.), cellular data radio, or wireless local area network radio. Because such radios may consume significant amounts of power even in standby mode, power consumption may be better optimized by selectively deactivating the radios whenever the application of the projector does not require them.

Electronic system 130 may also include input/output components which interface with external controllers. For example, in some applications for projector 100, electronic system 130 may activate an input/output component that interfaces with an external keyboard or remote, whether connected through a wired port or via a wireless protocol. In applications where this type of external controller is not appropriate, electronic system 130 may disable power to or ignore signals from the input/output component.

Software components may also be included in electronic system 130. Depending on the application of projector 100, the software may be selectively configured to provide a different on-screen display on projection surface 114 through projected light 112. The software may adjust or alter the standard user interface depending on the application, including changing the functions of buttons on an external controller or other peripheral device, and detecting and customizing the interface—including language preferences, date and time formats, and choice of units—based on location. Software in electronic system 130 may also be configured to, depending on the application of projector 100, quickly retrieve specific and tailored online technical support or troubleshooting through a help button.

Electronic system 130 may also include suitable sensors, cameras, or detectors and appropriate implementing software in order to provide the capability of interactivity with projector 100. Users may interact with projector 100 via voice, gestures, signals, presence in a particular area, selectively interrupting projected light 112 (i.e., “casting a shadow on” or blocking light for a particular part of an image) or by illuminating particular parts of the image from projection surface 114, for example, with a handheld laser pointer. Such interactivity may be desired for gaming or entertainment applications of projector 100. In other cases, it may be desired in controlling or navigating through a presentation.

Port 140 is adapted to receive connector 142 and each may be any suitable shape and may communicate via any suitable protocol, including HDMI, DisplayPort, USB, MCCS over DDC, MHL with CEC, MYDP, or any combination thereof. The connection of port 140 with connector 142 may facilitate rapid transfer of data between projector 100 and removable module 102. Initially, data outputted from projector 100, represented in FIG. 1 as outgoing data 160 indicates the capabilities and identity of projector 100 to removable module 102. In some embodiments this indication is communicated through the transmission of extended display identification data (EDID), though any suitable method or protocol may be used. Connector 142 receives this information and routes it to the suitable electronic read components. Return information 162 may indicate not only suitable or preconfigured settings for the various systems of projector 100, but also content to be projected via projected light 112. In some embodiments, port 140 may also supply power to removable module 102 via connector 142.

Removable module 102 may vary considerably in its components and manner of providing configuration information—and possibly content—to projector 100 via connector 142 and port 140. The removable module shown in FIG. 1 includes, for illustrative purposes, module electronic system 132 and content system 152.

Module electronic system 132 may contain any suitable components or systems to manage, operate, or power removable module 102 or even projector 100. Virtually any electronic component may be included in module electronic system 132 depending on suitable or desired applications. In embodiments where removable module 102 receives power through connector 142 from projector 100, module electronic system 132 may store, route, or control the flow of power throughout removable module 102. In other embodiments, particularly intensive computing applications of removable module 102, module electronic system 132 may power or selectively drive one or more cooling fans internal to removable module 102. Module electronic system 132 may be used to process data otherwise processed by components in projector 100, where it may be desired to have more computing power through parallel processors, or, alternatively, in embodiments or applications where more distributed power is desired, for example, where centralized processing may generate too much heat.

Content system 152 may include any suitable components which include those that receive, transmit, process, and generate content to be projected onto projection surface 114 through projected light 112. In some embodiments, content system 152 may include one or more wireless radios that receive streaming content from a wireless local area network, cellular data network, or other wireless data system. In some embodiments, content system 152 may process the data to be more optimally or efficiently communicated to projector 100 for projection. In some embodiments this may include decrypting content with one or more codecs to or from one or more suitable formats. Content system 152 may include internal memory for storing image or video data, including photographs, presentations, movies, or other audiovisual content.

It should be apparent to one with skill in the art that the groupings of functions and components into systems in the above description are only for purposes of simply classifying and illustrating the interaction among the various parts. While components are identified with specific systems in the above description, some or even significant interchangeability in classification or precise function does not depart from the scope of embodiments of the present description.

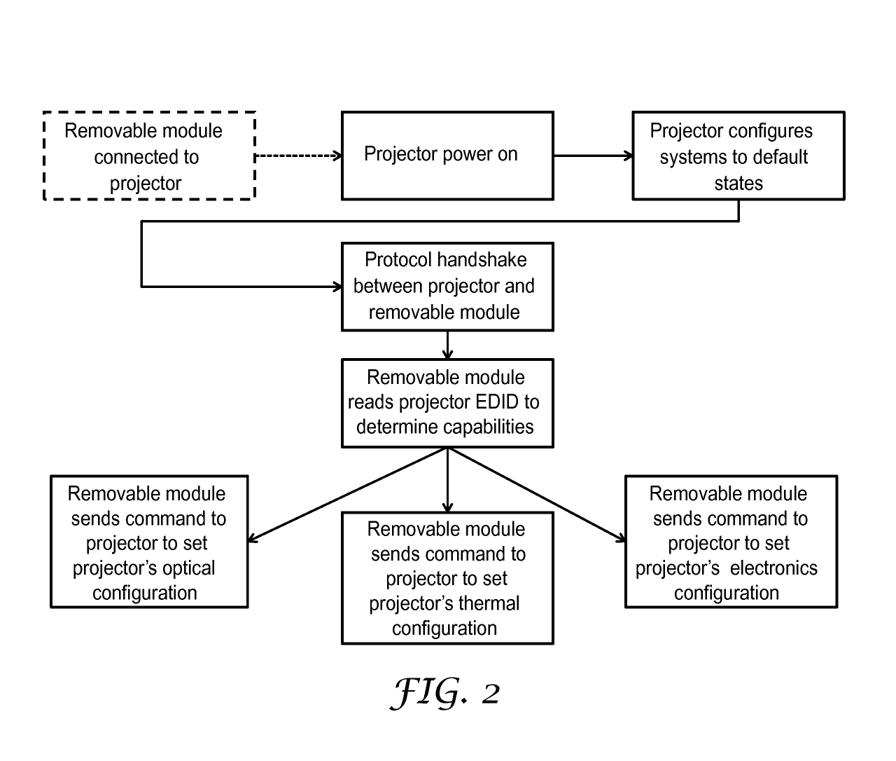

FIG. 2 is a diagram of a flow chart illustrating the general operation of one embodiment of the present disclosure. In particular, the flow chart illustrates the interaction between projector 100 and removable module 102 when the latter is connected to the former. For ease of explanation, the discussion of FIG. 2 will make reference to components illustrated and described above with respect to FIG. 1.

At some point, removable module 102 is connected to projector 100 via the insertion of connector 142 into port 140. This step is in a dashed box in FIG. 2 to indicate that, in some embodiments, the connection of the removable module need not be directly prior to the projector powering on, but rather, by the time the projected is powered on, the removable module should be connected.

Once the projector is powered on, the projector may configure itself to default states. Configuration means adjustments, calibrations, or changes to any or all systems 110, 120, 130, and 140. The default states may be predetermined and they may always be the same or they may be dependent on the last use or most common uses of the projector. At some point after configuration, the projector and removable module exchange a protocol handshake through port 140 and connector 142. This can include any suitable transfer of information with any suitable protocol.

In some embodiments, after the readying of the data transfer channels through the handshake, the removable module reads transmitted extended display information data from the projector. In addition to the EDID which may indicate capabilities, other data may be transmitted which indicates version information, model number, or other appropriate information related to the projector and its systems. Besides EDID, any other format for transmission of data may be used as long as sufficient information is passed from projector 100 to removable module 102 regarding the projector's display capabilities and systems.

After receiving information about the projector, removable module 102 sends one or more sets of commands that configure various systems and components on projector 100, depending on the removable module and its desired application. In some embodiments, the removable module sends a command to the projector to set the projector's optical configuration. This includes any adjustment or change to optical system 110. In other embodiments, the removable module sends a command to the projector to set the projector's thermal configuration, which includes any adjustment or change to thermal system 120. The removable module may also send a command to the projector to set the projector's electronic configuration, that is, make adjustments or changes to electronic system 130.

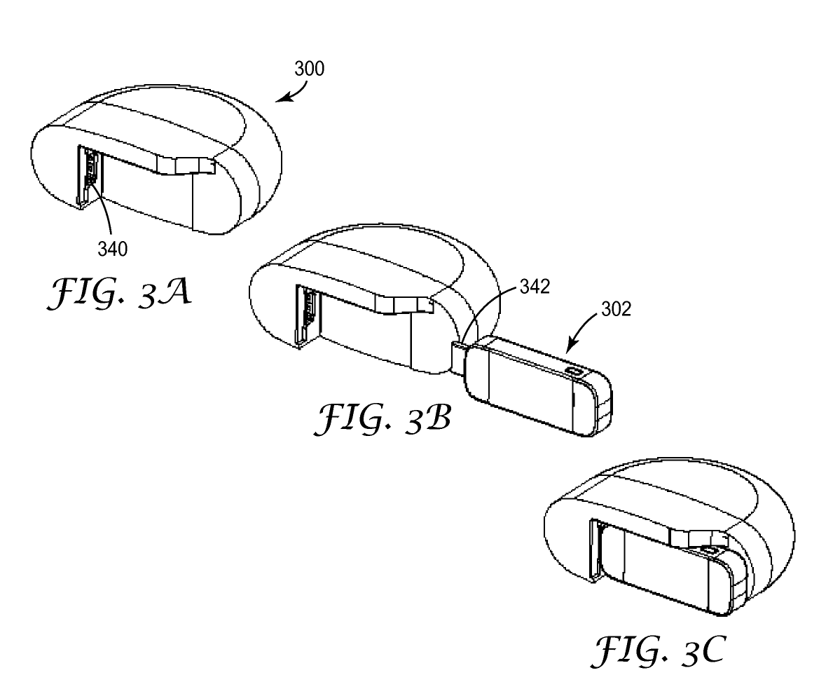

FIGS. 3A, 3B, and 3C show a sequence in which removable module 302 is connected to projector 300 via a connection between port 340 and connector 342. Removable module 302 may nestle within the frame of projector 300 as illustrated in FIG. 3C, or it can be designed or configured any other suitable manner.

Depending on the particular application of the projector and the particular mechanisms and electronics of the removable module, different configurations or combinations of configurations may be appropriate. For example, a removable module which the projector is adapted to receive may be configured to provide streaming movie content to be displayed by the projector. In this case, optimal parameters for movie viewing may be set, including reconfiguring optical system 110. Configuration may include adjusting brightness, contrast, gamma, color space, aspect ratio, or any other adjustable parameter. Similarly, thermal system 120 may be reconfigured to minimize disruptive fan noise, which may include running multiple fans at low speed. Electronic system 130 may be reconfigured to turn off extraneous radios, ports, components, or systems to maximize performance while minimizing heat generation and noise.

In another possible application, the removable module may be set to configure the projector as a general purpose computer monitor. In this application, the removable module may send commands to reconfigure optical system 110 in order to more clearly display text, for example. Thermal system 120 may be configured to provide maximum cooling, because fan noise may be less of a concern for use as a computer monitor. Further, electronic system 130 may be configured to activate external input devices such as a wireless keyboard, keypad, or mouse.

The above applications are just two of a virtually unbounded set of configurations and optimizations of projector 100 for the particular purpose or of removable module 102. By using the removable module to configure systems and components of projector 100, the projector can be repurposed to improve or tailor its operation to the particular functionality desired through the removable module.

In another sense, the present description may relate to an electronic unit. The electronic unit may include a projector such as the projector 100 described above, e.g., a pico projector. The electronic unit may further include a removable module that is connected to the projector, e.g. removable module 102 in FIG. 1. Removable module may be connected to the projector through a number of appropriate means, including a port of projector by MHL, HDMI or other appropriate connection, such as those ports discussed with respect to port 140. Additionally, the removable module may communicate to the projector through a wireless connection, such as Wi-Fi™, WiGiG™, Miracast™, or other appropriate wireless protocol. Where a wireless connection is utilized, governance of the first set of data being communicated to the projector from the removable module may occur through a software application.

When in operation, the removable module may communicate a first set of data to the projector. The first set of data may relate to various functions that are provided to the projector, including e.g., streaming movie, television or other audiovisual content, as well as other potential content discussed previously in the application. Additionally, the projector is capable of automatically adjusting (i.e. without user manually adjusting) its power consumption in response to the first set of data received from the removable module in order to optimize use time with the various functions. In at least one embodiment, the projector may alter its power consumption by dimming a light source that is used to project an image.

Removable module may be a number of appropriate devices capable of communicating a first or multiple sets of data to the projector. For example, the removable module may be a laptop, tablet, PC, DVD player or cable box. In a preferred embodiment, the removable module may be a streaming information sharing stick, module or drive, such as a “Streaming Stick™” from Roku, Inc.

In some embodiments, the information sharing device may communicate more than one set of data to the projector. For example, the removable module may communicate a plurality of sets of data following (temporally) the first set of data, such that that projector may continually alter its power consumption and other functionality in response to the sets of data received from the removable module.

One appropriate set of data that may be communicated to the projector from the removable module is the run time of a movie or television show. In response to receiving this data, the projector may alter its power consumption by dimming a light source used to projector or display the image of the movie or television in order to allow completion of the movie or television show. Additionally, the projector may be capable of sending a message back to the removable module that the power remaining for the projector power source is insufficient to complete a movie (or show) even if the light source is dimmed, thereby requiring a user to utilize an external power source. A prompt indicating this information may also be provided to the user of the projector. The projector itself will generally either be powered by a battery or other means discussed earlier in the description.

Another set of data that may be communicated to the projector from the removable module may be a pause or stop function. This communication may allow the projector to alter its power consumption by automatically turning off the projector light source used to projector or display the image until the pause or stop function is discontinued. Additionally, the first (or other) set of data communicated to the projector from the removable module may be that the removable module requires audio only. This set of data may allow the projector to alter its power consumption by automatically turning off the light source used to projector or display the image. Further, the first (or other) set of data communicated to the projector from a removable module may be the indication of a commercial or other break in the movie (or television show, for example) being projected. This set of data may allow the projector to alter its power consumption by automatically temporarily turning off or dimming a light source used to project or display the image.

In another sense, the present description relates to a method of continually controlling the power supply of an electronic device. Again, the electronic device may include a projector and a removable module. The method involves communicating a first set of data from the removable module to the projector regarding various functions being provided to the projector. The method further involves automatically altering the power consumption of the projector in response to the first set of data received from the removable module in order to optimize use time with the various functions. The removable module may be similar to the module described above (e.g., a streaming information sharing stick, module or drive). Additionally, the method may include the further steps of communicates a plurality of sets of data from the removable module to the projector following the first set of data, and continually altering the projector's power consumption and other functionality in response to the sets of data received from the removable module. Additionally, the first set of data communicated to the projector from the removable module comprises the run time of a movie, allowing the projector to alter its power consumption by dimming a light source used to project or display the image of the movie to allow completion of the movie. The other characteristics projector 100 and module 102 should also be understood to apply to the projector and module utilized in the currently described method.

The present invention should not be considered limited to the particular examples and embodiments described above, as such embodiments are described in detail in order to facilitate explanation of various aspects of the invention. Rather, the present invention should be understood to cover all aspects of the invention, including various modifications, equivalent processes, and alternative devices falling within the scope of the invention as defined by the appended claims.

1. An electronic unit, comprising:
a projector; and
a removable module connected to the projector, wherein the removable module communicates a first set of data to the projector regarding various functions that are provided to the projector; and
wherein the projector automatically alters its power consumption in response to the first set of data received from the removable module in order to optimize use time with the various functions.

2. The electronic unit of claim 1, wherein the projector alters its power consumption by dimming a light source used to project an image.

3. The electronic unit of claim 1, wherein the removable module communicates a plurality of sets of data following the first set of data, such that the projector may continually alter its power consumption and other functionality in response to the sets of data received from the removable module.

4. The electronic unit of claim 3, wherein the projector comprises a pico projector.

5. The electronic unit of claim 1, wherein the removable module comprises a streaming information sharing stick, module or drive.

6. The electronic unit of claim 1, wherein the removable module is a laptop, tablet, PC, DVD player, or cable box connected into a port of the projector by MHL, HDMI or other connection.

7. The electronic unit of claim 1, wherein the first set of data communicated to the projector from the removable module comprises the run time of a movie, allowing the projector to alter its power consumption by dimming a light source used to project or display the image of the movie to allow completion of the movie.

8. The electronic unit of claim 7, wherein the projector is capable of sending a message to the removable module that power remaining in a projector power source is insufficient to complete a movie even with dimming of the light source, thereby requiring a user to utilize an external power source.

9. The electronic unit of claim 1, wherein the first set of data communicated to the projector from the removable module comprises a pause or stop function, allowing the projector to alter its power consumption by automatically turn off a light source used to project or display the image.

10. The electronic unit of claim 1, wherein the first set of data communicated to the projector from the removable module comprises the use of audio only, allowing the projector to alter its power consumption by automatically turning off a light source used to project or display the image.

11. The electronic unit of claim 1, wherein the first set of data communicated to the projector from the removable module comprises a commercial or other break, allowing the projector to alter its power consumption by automatically temporarily turning off or dimming a light source used to project or display the image.

12. The electronic unit of claim 1, wherein the removable module is connected to the projector through a wireless connection.

13. The electronic unit of claim 12, wherein the removable module and projector communicate wireless through a Wi-Fi, WiGiG, Miracast, or other wireless protocol.

14. The electronic unit of claim 12, wherein the governance of the first set of data being communicated from the removable module to the projector occurs through a software application.

15. The electronic unit of claim 1, wherein the projector comprises a battery or power adapter that provides power to the device.

16. A method of continually controlling the power supply of an electronic device, the electronic device comprising a projector and removable module, the method comprising:
communicating a first set of a data from the removable module to the projector regarding various functions being provided to the projector, and
automatically altering the power consumption of the projector in response to the first set of data received from the removable module in order to optimize use time with the various functions.

17. The method of claim 16, wherein the removable module comprises a streaming information sharing stick, module or drive.

18. The method of claim 16, further comprising the steps of communicates a plurality of sets of data from the removable module to the projector following the first set of data, and continually altering the projector's power consumption and other functionality in response to the sets of data received from the removable module.

19. The method of claim 16, wherein the first set of data communicated to the projector from the removable module comprises the run time of a movie, allowing the projector to alter its power consumption by dimming a light source used to project or display the image of the movie to allow completion of the movie.
